(19) United States
(12) Patent Application Publication
(10) Pub. No.: US 2010/0251732 A1
(43) Pub. Date: Oct. 7, 2010

(54) APPARATUS AND METHOD FOR INTRODUCTION OF A MATERIAL INTO A CRYOGENIC SYSTEM

(75) Inventors: Andrew Michael Leach, Clifton Park, NY (US); James Richard Trigger, Rotterdam Junction, NY (US); John Arthur Urbahn, Saratoga Springs, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, Schenectady, NY (US)

(21) Appl. No.: 12/418,649

(22) Filed: Apr. 6, 2009

(51) Int. Cl. F25B 19/00; F25B 21/00; B65B 39/00; B01L 3/02

(52) U.S. Cl. 62/51.1; 62/3.1; 141/331; 422/100

(57) ABSTRACT

Provided is an apparatus and method for introducing a sample into a cryogenic system comprising, an airlock chamber, a sample path having a first end connected to the airlock chamber and a second end connected to a cryogenic helium bath, an equilibrator, inserted into the sample path and positioned between the airlock and the cryogenic bath and which allows for passage of a sample to the cryogenic helium bath, and a cooling unit to coupled to the equilibration to control the temperature of the equilibrator. A machine-readable medium, comprising instructions which when executed by a controller causes a sample to be positioned within the cryogenic system, is also provided.

### BACKGROUND

Dynamic nuclear polarization (DNP) is a technique that generates an excess of one nuclear spin relative to the other orientation. This excess can be on the order of several thousand-fold at cryogenic temperatures and several hundred thousand-fold at room temperature. This increase in population of one nuclear spin relative to the other is seen as an increase in the signal-to-noise ratio of measurements in nuclear magnetic resonance (NMR) systems such as magnetic resonance imagers (MRI).

To achieve high levels of polarization via DNP, materials or samples must be cooled to extremely low temperatures, often less than four Kelvin and optimally in the range of one Kelvin. These low temperatures are typically achieved by reducing the pressure above a volume of liquid helium. As the pressure above the helium bath is reduced the temperature of the bath is reduced as defined by the saturation curve of liquid helium. The introduction of warm samples into this environment can significantly impact the temperature of the helium bath as well as the polarization of any samples that are already present in the bath. Additionally, the process of cooling samples results in the vaporization of liquid helium from the helium bath, impacting the duration the helium bath can be maintained and the number of samples that can be processed.

A conventional means of reducing the pressure above a helium bath is the use of one or more mechanical pumps. These pumps expel helium into the ambient environment as a result of this pumping process, making it difficult and expensive to reuse the cryogen. The quantity of helium in this bath can be either static, being filled before the pumping is initiated, or dynamic through the use of a second helium reservoir connected to the pumped region via a regulated passageway such as a needle valve. The static system often exhibits a limited operational period due to size constraints of the helium bath. The dynamic system, although more flexible, contains mechanical components within the cryogenic environment, potentially limited the robustness of the device.

A sorption pump may be used in a closed cycle cryogenic system that is designed to generate one-Kelvin temperatures without loosing cryogen (liquid helium) volume. This sorption pump contains a charcoal-based sorbent that absorbs gaseous helium at low temperatures, thus acting as a means to reduce the pressure above a volume of liquid helium. When the temperature of the charcoal is elevated the gaseous helium is released from the sorption pump, thus acting as a source of helium for the liquid helium bath. This sorption pump may be operated in a cyclic fashion that first condenses liquid helium and then reabsorbs the helium while generating reduced temperatures. In this cyclic manner of operation the total volume of cryogen remains constant. The fact that this system operates without loosing cryogen volume is a significant benefit to ease of operation by eliminating the need for frequent cryogen transfers as well as a cost savings through the elimination of cryogen purchases.

However, a limitation of this system is that during the condensation portion of the sorption pump cycle, the volume of liquid helium generated is limited by several geometric considerations including the mass of charcoal, the amount of gaseous helium loaded into the charcoal and the physical size of the container into which the helium is condensed. Because of this limited volume of liquid helium the amount of heat directed to the helium bath directly impacts the amount of material or number of samples that can be cooled and polarized during one thermal cycle.

### BRIEF DESCRIPTION

The present invention overcomes the aforementioned drawbacks by providing an apparatus and method for introducing material into a cryogenic system with minimal impact to the thermal performance of the system by directing heat from the introduced material away from the liquid helium bath and to a cooling unit.

In an embodiment, an apparatus for introducing a sample into a cryogenic system is provided. The apparatus comprises an airlock chamber, a sample path having a first end connected to the airlock chamber and a second end connected to a cryogenic helium bath, an equilibrator, inserted into the sample path and positioned between the airlock and the cryogenic bath and which allows for passage of a sample to the cryogenic helium bath, and a cooling unit to couple to the equilibrator to control the temperature of the equilibrator.

In another embodiment a method for introducing a sample into a cryogenic system is provided comprising the steps of loading the sample into an airlock chamber, evacuating the airlock chamber and inserting the sample from the airlock chamber into a sample path. The method also comprises lowering the sample into an equilibrator located within the sample path, conducting heat from the sample to a cooling unit connected to the equilibrator through a thermal linkage, and inserting the sample from the equilibrator into a lower section of the sample path and into a cryogenic helium bath.

In another embodiment a machine-readable medium, comprising instructions which when executed by a controller causes a sample to be positioned within the cryogenic system, is provided.

### BRIEF DESCRIPTION OF THE DRAWINGS

The drawings illustrate an embodiment presently contemplated for carrying out the invention.

FIG. 1 is a schematic illustration of the sample path within the cryogenics system.

FIG. 2 is a thermal profile of the cryogenic helium bath and cooling unit using the unidirectional sample loading procedure.

FIG. 3 is a thermal profile of the cryogenic helium bath and cooling unit using the bidirectional sample loading procedure.

### DETAILED DESCRIPTION

The following detailed description is exemplary and not intended to limit the invention of the application and uses of the invention. Furthermore, there is no intention to be limited by any theory presented in the preceding background of the invention or the following detailed description of the drawings.

Provided herein are methods and apparatus for the introduction of a sample into a cryogenic system from ambient temperatures. Cryogenic systems are often used in medical imaging, power generation and scientific research applications. Cryogenic systems are also used in apparatuses for hyperpolarization of samples and are described in co-owned U.S. patent application Ser. No. 11/692,642 and U.S. patent application Ser. No. 11/766,881, which are hereby incorporated by reference.

In one embodiment, an apparatus for introducing a material into a cryogenic system from ambient temperature through a sample path is provided. The sample path connects an airlock chamber on one end to a cryogenic chamber on the other end and is thermally linked to a cooling unit. The dimension and geometry of the sample path may vary based on the application. The sample path may consist of a series of separate segments. In one embodiment, the sample path may comprise two thin walled tubes located at opposing ends of an equilibrator. The equilibrator is a tubular structure comprised of a high thermally conductive material, such as copper, and is thermally linked to a cooling unit. The two thin walled tubes may be comprised of a low thermally conductive material such as steel. The tubes may also be corrugated to reduce the conductive thermal loads. To minimize radiative heating, the sample path may be configured to geometrically offset the two tubes located at opposing end of the sample path such that there is no direct line of sight from the entrance of the first tube to the exit of the second tube. Such an offset can be established by fixing the two tubes parallel to one another but laterally offset with the equilibrator. The diameters of the tubes may be minimized to restrict heat loads, but be of sufficient diameter to allow samples to pass through.

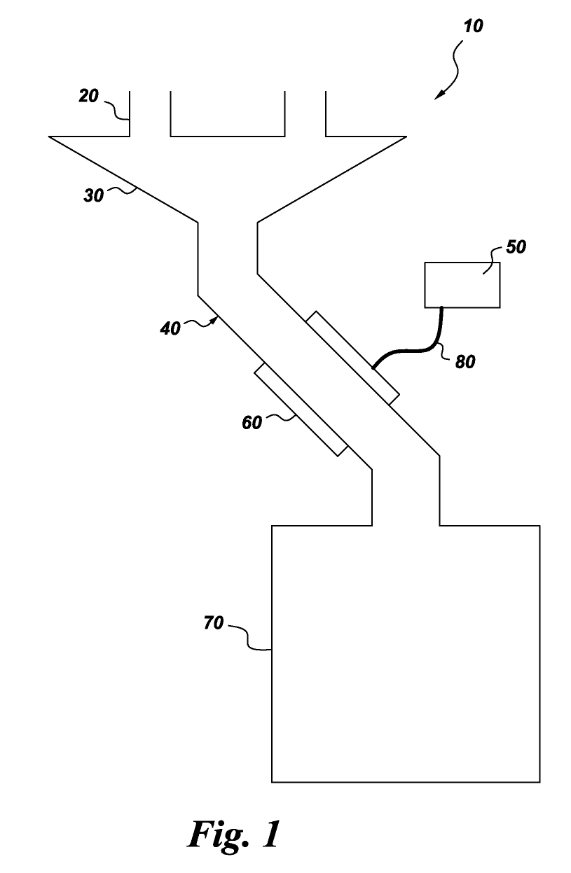

As shown in FIG. 1 materials may be introduced from ambient temperature and pressure into a cryogenic system through a sample path 10. This passage consists of an airlock 20 that allows for samples to move from ambient pressure into the lower pressure environment of the cryogenic system, a funnel 30 that directs multiple samples into a common path in order to reduce heat loads to the system, and a tube 40 that connects the funnel to the cryogenic helium bath 70. A section of the sample path functions as an equilibrator, 60 and is constructed of a material with a high thermal conductivity, such as copper. The equilibrator is thermally linked to a cooling unit 50, which typically operation at temperatures less than 10 Kelvin. The equilibrator and the cooling unit, allows samples, introduced at ambient conditions, to equilibrate with the cryogenic system before introducing the samples into the cryogenic helium bath. The cooling unit may be a refrigeration unit, such as a stored liquid or solid cryogen cooling system, or a continuous flow cryostat. The cooling unit is connected to the equilibrator by a thermal refrigeration link 80. The refrigeration link may be comprised of a high thermally conductive material, such as copper. In certain embodiment the refrigeration link may be braided copper.

If multiple samples are to be admitted to the cryogenic helium bath a common path may be used. Such a common path may use a funnel at the entrance of the first steel tube to direct multiple samples to the cryogenic helium bath. An example of a sample path is two 0.750-inch inner diameter corrugated tubes connected to a 0.750-inch inner diameter copper tube. The first corrugated steel tube is attached to a funnel that enables the simultaneous direction of four or more samples to the helium bath. The samples are 0.125-inch outer diameter tubes with 0.500-inch outer diameter bulbs located at the distal tips. The sample path inner diameter is large enough to simultaneously accommodate one sample bulb and three sample tubes. This configuration dictates that although four samples can be present in the helium bath simultaneously, only one sample can be moved though the 0.750-inch inner diameter sample path at a given point in time. The cooling unit employed in this arrangement may be a two stage Sumitomo SRDK-415D cryogenic cooling system. In other embodiments, the cooling unit may be a cryogen cooling system operating at a temperature of approximately four Kelvin such as any Gifford-McMahon (GM) type cyrocooler.

One or more samples may be initially loaded into the airlock where the surrounding air is removed and replaced with a cryogenic gas such as helium. The pressure in this airlock is reduced to more closely match the pressure within the cryogenic system. A dynamic seal or baffle may be used to maintain pressure. At least one sample is lowered from the airlock chamber into the distal end of the sample path, and directed to the equilibrator. The sample is positioned within the equilibrator where contact with the highly conductive material of the equilibrator allows for conduction of heat from the sample to the cooling unit.

Imperfections in the surface of the sample and the equilibrator may limit the amount of heat transferred via conduction, thus convective cooling may also be used to transfer heat from the sample to the equilibrator. To generate an environment suitable for convection, a limited quantity of heat may be directed to the cryogenic helium bath resulting in a modest increase in pressure within the sample path.

In one embodiment, the cryogenic bath contains liquid helium. The magnitude of this pressure increase is directly related to the temperature of the liquid helium and thus this pressure increase is typically small in order to not impact the processing of other samples, which may reside in the bath. Pressures of 0.055 and 0.096 millibar can be achieved within the sample path while only increasing the helium bath's temperature to 0.90 and 0.95 Kelvin, respectively, based on the liquid helium saturated vapor pressure relationship. In practice it is desirable to maintain this pressure below 0.1 millibar. However, this maximum temperature excursion is balanced by the need for rapid sample introduction. Higher pressures and thus temperatures will enhance heat flow from the warm sample to the cryogenic refrigerator, thus enabling the acceleration of sample introduction, but at the cost of increase temperature fluctuations within the cryogenic helium bath.

Convective cooling may be utilize by introducing a sample in to the system and positioning the sample below the equilibrator in successive steps, where each step brings the samples closer to the cryogenic helium bath. After each repositioning of the sample a time delay allows helium gas, collected in the sample path space during the repositioning process, to transfer heat from the sample to the equilibrator via convection. In one embodiment, the values for this sample introduction procedure include three five-centimeter movements (5, 10 and 15 cm below the equilibrator) with five-minute delays between movements. The number, location and duration of repositioning steps may be empirically determined and adjusted based on operating conditions and geometry of the system.

In one embodiment, a positioning system may be used to position samples within this sample path in a manner that would control conductive and convective heat transfer from samples to the equilibrator. The positioning system may be manual motion based on graduated markings on a sample delivery device. Alternatively, robotic systems with feedback control may be used to precisely control the location of the sample within the sample path. Such a robotic system may be fabricated from pitch wheels that drive a sample delivery device into the sample path. The pitch wheels may further provide feedback regarding sample positioning through the use of an idler wheel that measures sample slippage.

After the final repositioning step the sample may be introduced into the cryogenic helium bath with minimal impact on the helium bath temperature. This method provides a method for thermal conditioning of samples, by controlling the distance between the sample and the equilibrator during successive steps, which may limits the transfer of heat to the equilibrator while simultaneously allowing for heat transfer to be directed to the cryogenic helium bath.

In one embodiment of the sample introduction method, the sample may be positioned below the equilibrator for brief durations to increase pressure within the sample path due to collection of helium gas, and then returned to the equilibrator to allow for enhanced transfer of heat from the sample to the equilibrator rather than the cryogenic helium bath. To generate this increase in pressure within the sample path the sample may be lowered to successively lower positions before returning to the equilibrator for heat transfer. For example, a sample introduction procedure may include six steps where the sample is positioned 3.75, 5.00, 5.56, 5.63, 5.75 and 10.00 cm below the equilibrator for five seconds before returning to the equilibrator for delays of two minutes to allow for heat transfer. The number, location and duration of these steps may be determined empirically and may be changed based on the geometry and conditions.

An advantage of using successive steps in lowering and repositioning a sample may be that the sample related heat loads are predominately directed to a cooling unit rather than the liquid volume of the cryogenic bath. The impact on the temperature of the cryogenic liquid volume resulting from the introduction of samples is minimized.

In another embodiment, the invention provides a method to allow a modest increase in gas pressure of the cryogenic bath coolant within the sample path during equilibration steps. This increase in pressure can be achieved through introduction of a warm sample in the headspace above the cryogenic helium bath. A combination of conductive, convective, and radiative heating from the warm sample to the cooled helium bath will result in a local increase in pressure and thus an increase in convective heat transfer to the surrounding environment. A portion of the convective heat will be directed to the highly conductive portion of the sample path and transferred to the cooling unit via the thermal linkage. The magnitude of the pressure increase and the proximity of the warm sample relative to the highly conductive section of the sample path will dictate the percentage of heat directed to the cooling unit relative to the cryogenic helium bath. The heat flow to the cooling unit may be increased by repositioning the warm sample within the equilibrator region of the sample path following the increase in pressure. This process may be repeated till the sample is sufficiently cooled to introduce the sample to the cryogenic helium bath with minimal impact of the bath's characteristics.

Alternatively, a separate heat source local to the cryogenic helium bath may be used to increase the pressure within the sample path. Although this approach would reduce the need for repositioning of the sample to generate the pressure increase, this approach may introduce an additional heat source into the system thus potentially impacting other system characteristics including helium bath temperature of service life.

By employing successive steps, the impact of the sample loading related heat on the volume of cryogenic liquid in the cryogenic helium bath may be minimized. This may increase the maximum number of samples that can be processed during one cycle of a sorption pump in a cryogenic system be increased. The combination of convective and conductive cooling may also allow rapid cooling of samples without the need for physical movement of mechanical parts within the cryogenic system, such as equilibrator components that apply pressure to the sample to enhance conduction.

In one embodiment, a machine-readable medium comprising instructions which when executed by a controller coupled to the cryogenic system may be used. The machine-readable medium may control the loading of samples, position of the sample in the sample path, and provide a means for monitoring and controlling temperature and pressure within the cryogenic system.

### EXAMPLES

Methods on operating the equilibrator were developed by repetitively introducing samples into the cryogenic system and measuring the temperature of the cryogenic helium bath as well as the volume of liquid helium consumed. Cryogenic helium bath temperature was monitored with ruthenium oxide temperature sensors located on the helium bath container. The volume of liquid helium volume consumed per sample was calculated by (1) determining the duration a known quantity of liquid helium would remain in the cryogenic vessel as a result of parasitic heat loads and (2) the decrease in this duration as a result of introducing a known number of samples.

### Example 1

### Unidirectional Sample Loading Procedure

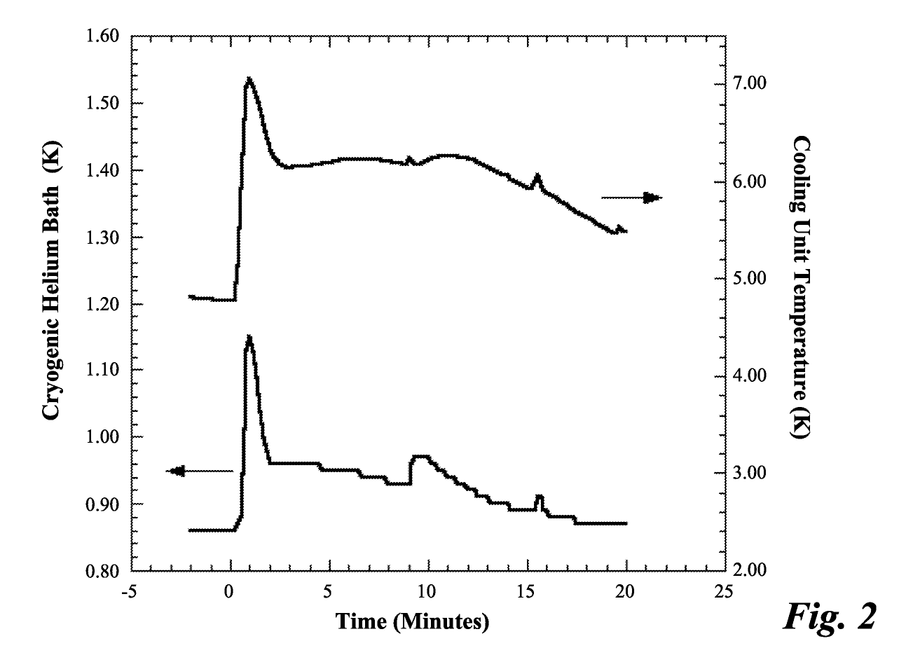

A 2.0 g sample of glycerol was pre-cooled to 77 K prior to introduction into the cryogenic system's airlock. The temperature of this sample increase during the loading process but the exact temperature of the sample prior to movement into the cryogenic system's sample path is unknown. The sample was lower to the equilibrator where it was allowed to remain for six minutes. Next, the sample was lowered to a position five centimeters below the equilibrator and allowed to remain for six minutes. The sample was then positioned 10 centimeters below the equilibrator and allowed to remain for six minutes. Finally the sample was inserted into the cryogenic helium bath. An example of the temperature of the cryogenic helium bath and the temperature of the cooling unit during sample loading is shown in FIG. 2.

### Example 2

### Bidirectional Sample Loading Procedure

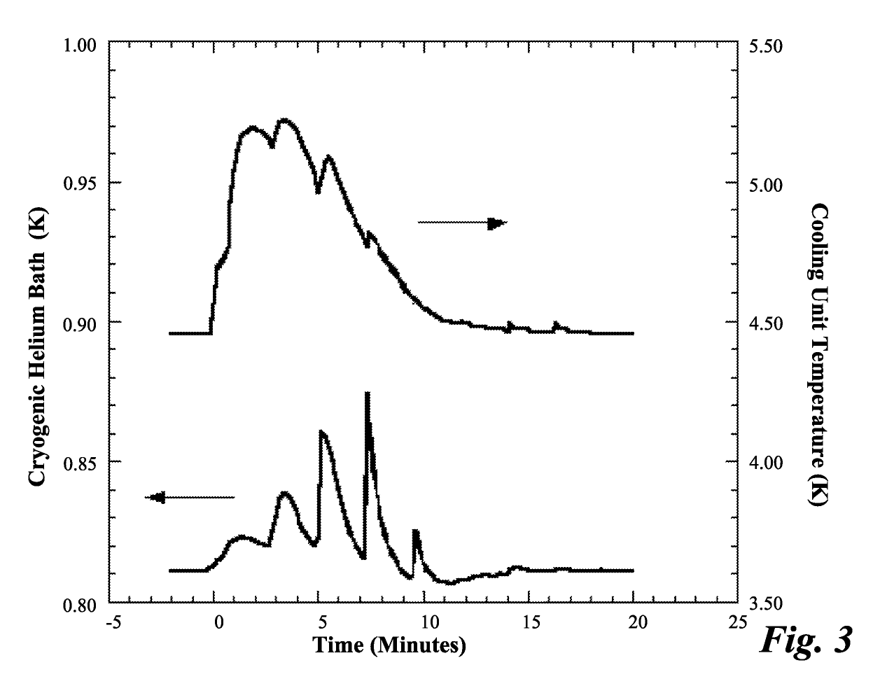

A 0.8 g sample of pyruvic acid was warmed to room temperature (nominally 293 K) prior to introduction into the cryogenic system. The sample was lower to the equilibrator where it remained for three minutes. The sample was then lowered to 3.75 cm below the equilibrator where it remained for five seconds before returning to the equilibrator where it remained for two minutes. This procedure was repeated to depths of 5.00, 5.56, 5.63, and 5.75 cm below the equilibrator in successive steps. The sample was then lowered to 10 cm below the equilibrator where it was allowed to remain for two minutes. Finally the sample was inserted into the cryogenic helium bath. An example of the temperature of the cryogenic helium bath and the temperature of the cooling unit during sample loading is shown in FIG. 3. Using this method approximately 4% of the samples heat was directed to the cryogenic helium bath corresponding to 22 cc/sample of helium consumed.

The invention may be embodied in other specific forms without departing from the spirit or essential characteristics thereof. The foregoing embodiments are therefore to be considered in all respects as illustrative rather than limiting on the invention described herein. The scope of the invention is thus indicated by the appended claims rather than by the foregoing description, and all changes that come within the meaning and range of equivalency of the claims are therefore intended to be embraced therein.

We claim:

1. An apparatus for introducing a sample into a cryogenic system comprising:
an airlock chamber;
a sample path having a first end connected to the airlock chamber and a second end connected to a cryogenic helium bath;
an equilibrator, inserted into the sample path and positioned between the airlock and the cryogenic helium bath and which allows for passage of a sample to the cryogenic helium bath; and
a cooling unit coupled to the equilibrator to control the temperature of the equilibrator.

2. The apparatus of claim 1 wherein the airlock chamber allows insertion of samples into the cryogenic chamber while maintaining a vacuum in the cryogenic chamber.

3. The airlock chamber of claim 2 said airlock chamber comprising a dynamic seal or baffle.

4. The apparatus of claim 1 wherein the cooling unit is a refrigeration unit, a stored liquid or solid cryogen cooling system, or a continuous flow cryostat.

5. The apparatus of claim 4 wherein the cooling unit has a thermal performance at temperatures less than 10 Kelvin and is connected to the equilibrator by a thermal refrigeration link.

6. The apparatus of claim 5 wherein the thermal refrigeration link is a high thermally conductive material.

7. The apparatus of claim 8 wherein the high thermally conductive material is copper.

8. The apparatus of claim 1 wherein the sample path comprises a series of linked tubular structures with the upper and lower tubular structures having low thermal conductivity.

9. The apparatus of claim 1 wherein the equilibrator is comprised of a high thermally conductive material.

10. The apparatus of claim 10 wherein the high thermally conductive material is copper.

11. The apparatus of claim 1 further comprising a funnel positioned between the airlock chamber and sample path, said funnel comprising a conical region adjacent to the airlock chamber and a narrowed region adjacent to the sample path.

12. The apparatus of claim 1 further comprising a positioning system to control the position of the sample in the sample path.

13. The apparatus of claim 12 wherein the positioning system comprises a robotic systems with feedback control to control the location of the sample within the sample path.

14. The apparatus of claim 1 further comprising a heat source coupled to the cryogenic helium bath to increase pressure within the sample path.

15. The apparatus of claim 1 wherein the cryogenic system is part of a hyperpolarizer system.

16. A method for introducing a sample into a cryogenic system comprising:
loading the sample into an airlock chamber;
evacuating the airlock chamber;
inserting the sample from the airlock chamber into a sample path;
lowering the sample into an equilibrator, said equilibrator located within the sample path;
conducting heat from the sample to a cooling unit connected to the equilibrator through a thermal linkage; and
inserting the sample from the equilibrator into a lower section of the sample path and into a cryogenic helium bath.

17. The method of claim 16 wherein the lowering step comprising lowering the sample from the equilibrator into the cryogenic helium bath in successive steps wherein each steps reduces the distance between the sample in the sample path and the cryogenic helium bath.

18. The method of claim 17 wherein the lowering step further comprises retracting the sample into the equilibrator after each successive step.

19. The method of claim 16 wherein the cryogenic system is part of is part of a hyperpolarizer system.

20. A machine-readable medium comprising instructions which when executed by a controller causes the cryogenic system to perform the method of claim 16.
